(19) United States
(12) Patent Application Publication
(10) Pub. No.: US 2014/0229860 A1
(43) Pub. Date: Aug. 14, 2014

(54) Activity Cards

(71) Applicant: MICROSOFT CORPORATION, Redmond, WA (US)

(72) Inventors: March Rogers, Bellevue, WA (US); Benjamin B. Gitenstein, Seattle, WA (US); Imran Aziz, Seattle, WA (US); Gail Giacobbe, Seattle, WA (US); Stefanie J. Danhope, Seattle, WA (US); Javier Porras Luraschi, Redmond, WA (US)

(73) Assignee: MICROSOFT CORPORATION, Redmond, WA (US)

(21) Appl. No.: 13/766,559

(22) Filed: Feb. 13, 2013

(51) Int. Cl. G06F 3/048

(52) U.S. Cl. CPC G06F 3/048
USPC 715/753

(57) ABSTRACT

The description relates to activity cards. One example can allow a user to select a recipient of an activity card. The example can receive feedback from the recipient regarding at least one of a location, a time, and further recipients of the activity card. The example can also send an updated activity card to the user and the recipient that reflects the feedback.

### BACKGROUND

Consumers often use telephone calls, email and short message service (SMS) to communicate and organize group activities, which can lead to fragmentation of information around an activity and make event details hard to find. For example, phone calls and SMS do not support group communications. Email can support group communications, but long threads can develop which can obfuscate details and whether the details are agreed upon. Accordingly, various participants may propose conflicting changes to the details of the activity, such that the activity is never actually agreed upon and/or there is confusion about the details of the activity. As such, the activity may never actually occur and/or participants may be inconvenienced by the confusion.

### SUMMARY

The described concepts relate to activity cards. One example can allow a user to select a recipient of an activity card. The example can receive feedback from the recipient regarding at least one of a location, a time, and further recipients of the activity card. The example can also send an updated activity card to the user and the recipient that reflects the feedback.

Another example can receive user input relating to an activity. This example can generate an activity card based upon the activity. This example can populate the activity card with content derived from the user input. The example can also obtain additional user input that defines at least one recipient of the activity card. The example can further cause the activity card to be sent to the recipients.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1A-1E and 2A-2C illustrate a computing device upon which activity card functionalities can be accomplished in accordance with some implementations of the present concepts.

FIGS. 3-4 illustrate examples of systems upon which activity card functionalities can be accomplished in accordance with some implementations of the present concepts.

FIGS. 5-7 are flowcharts of activity card methods that can be accomplished in accordance with some implementations of the present concepts.

### DETAILED DESCRIPTION

### Overview

This patent relates to activity cards. An activity card can make getting together with friends a snap. An activity card can float an idea as a digital postcard, use group chat to settle the details, and then share enjoyable moments with each other. An activity can be thought of as an expression of user interest with the intent of scheduling one or more events related to the activity. An activity can contain entities such as: participants, events, times, dates, places, lists, and/or media. An activity card can be thought of as containing static and/or dynamic details around an activity. An activity card can function as a data container that fosters agreement and discussion around an activity and can persist the activity card data before, during, and after the activity occurs.

### FIRST SCENARIO EXAMPLES

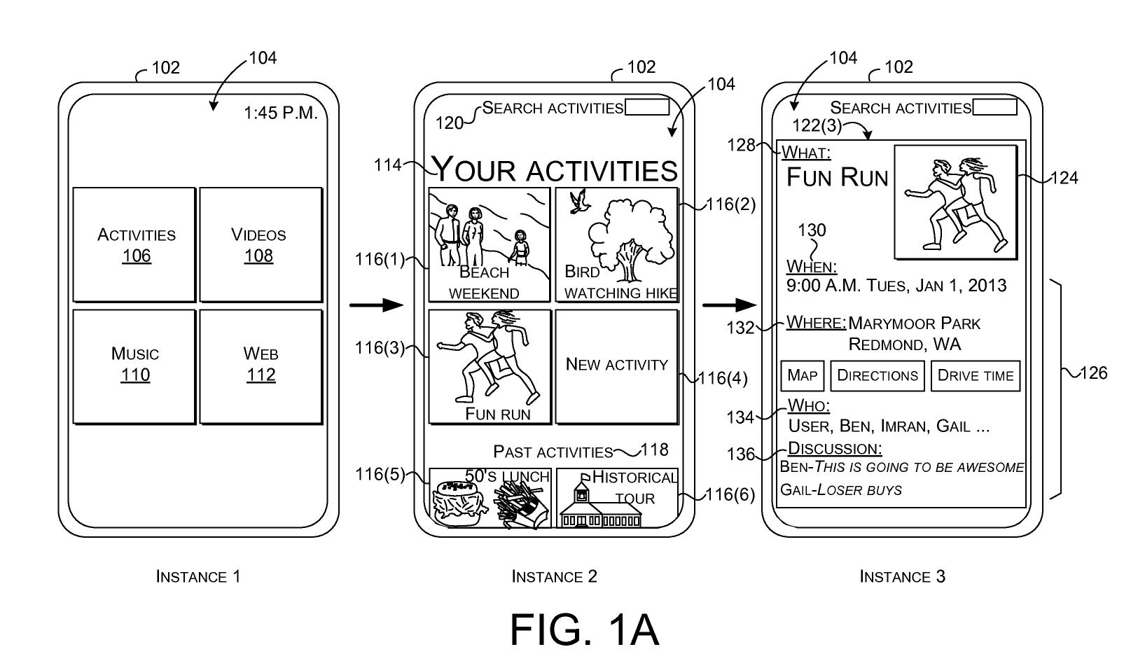

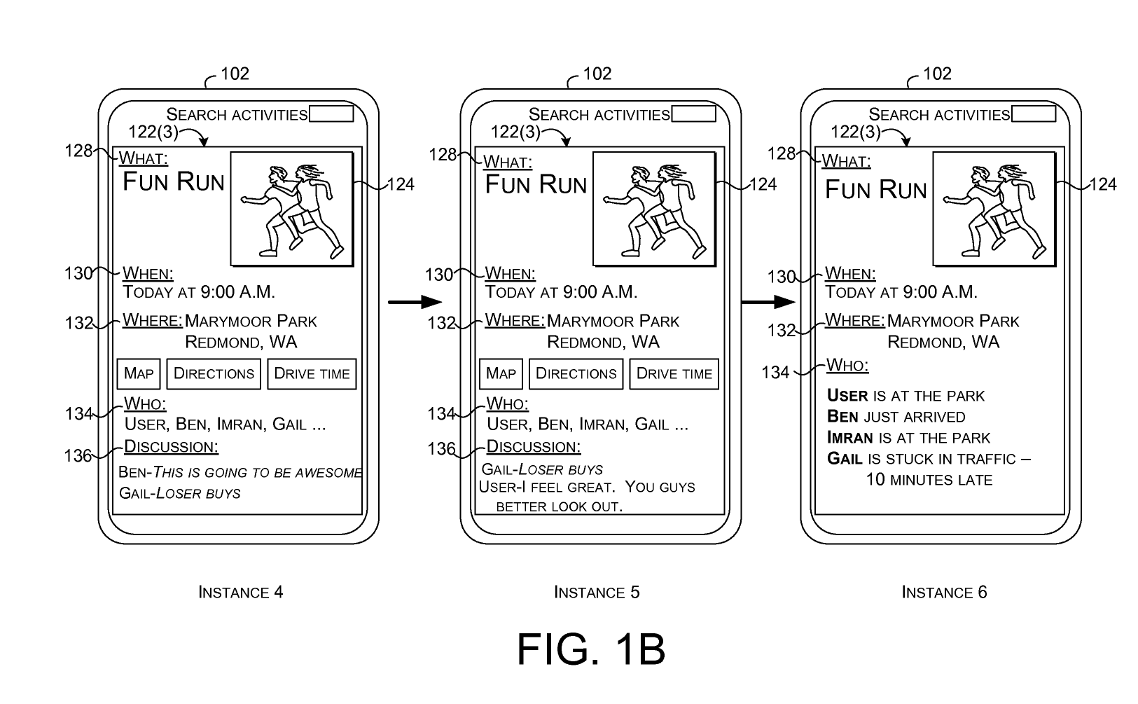

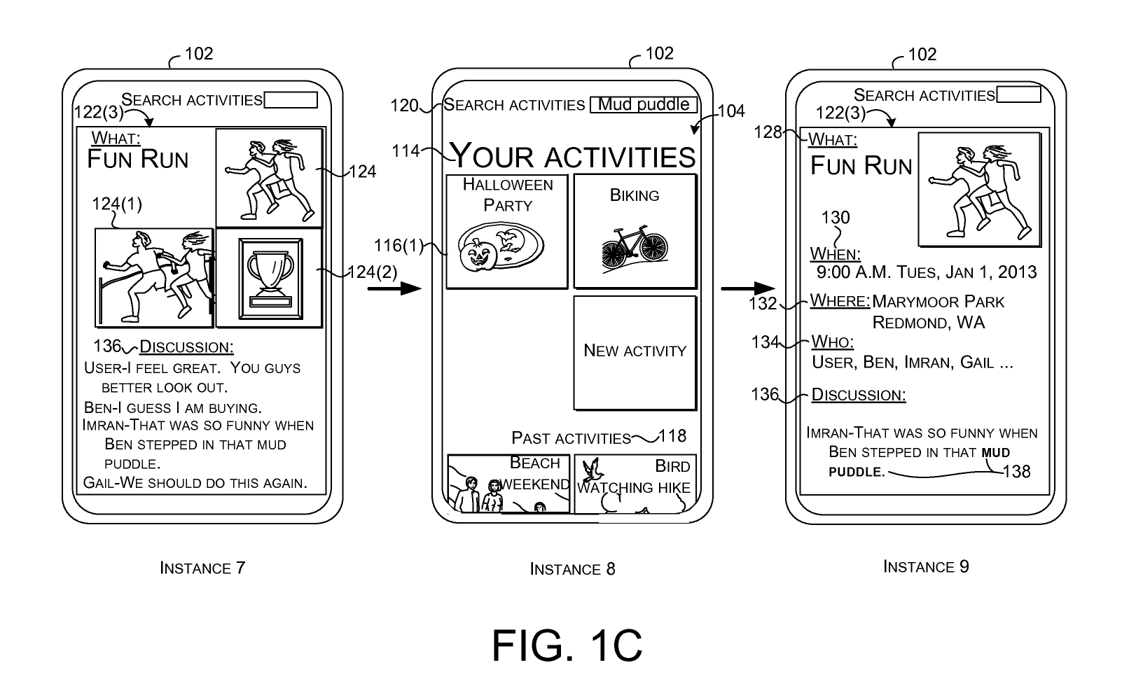

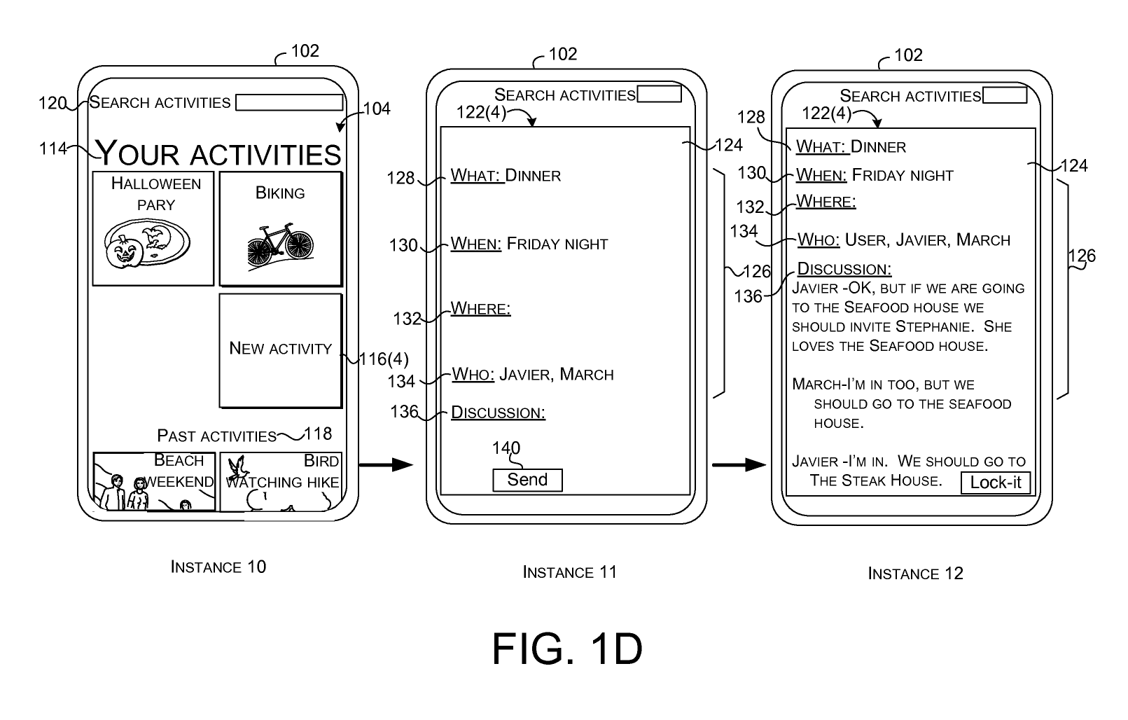

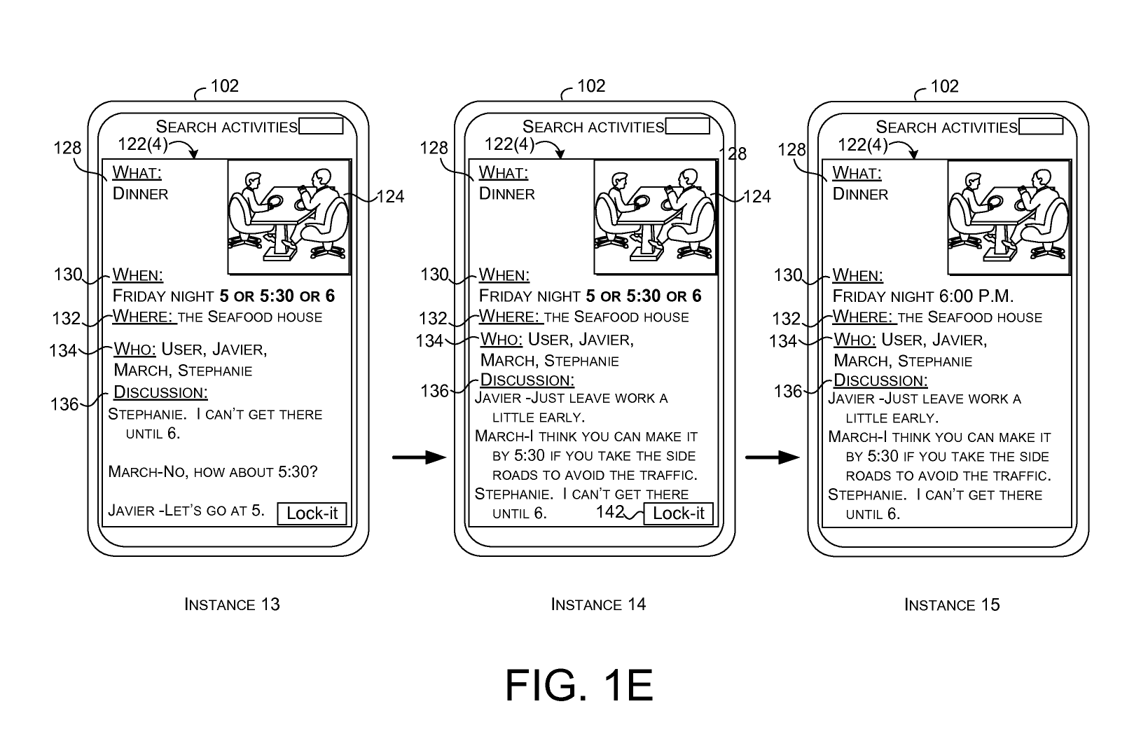

For purposes of explanation consider FIGS. 1A-1E which show a computing device 102 in several consecutive instances (e.g., FIG. 1A shows instances 1-3, FIG. 1B shows instances 4-6, FIG. 1C shows instances 7-9, FIG. 1D shows instances 10-12, and FIG. 1E shows instances 13-15). In this example, computing device 102 is manifest as a smart phone type mobile computing device that can present a graphical user interface (GUI) 104. However, the concepts apply to other types of computing devices, such as notebook computers, desktop computers, and/or tablet computers, among others.

In this example, the computing device 102 can provide multiple functionalities or features to the user. As illustrated in Instance 1, the features can include an activities functionality 106, a video functionality 108, a music functionality 110, and a web browsing functionality 112. Of course, the computing device can include alternative or additional functionality, such as a camera functionality and a phone functionality, among others. Assume for purposes of explanation that in Instance 1, the user has selected the activities functionality 106.

Instance 2 shows the computing device 102 responsive to the user selection related to Instance 1. In this case, the computing device is now displaying features relating to the activities functionality 106. For example, a “Your Activities” header 114 shows three existing activities for the user of the computing device 102. In this configuration, these activities can be represented as activity card previews 116. In this case, a first activity card preview 116(1) relates to a “Beach Weekend”, a second activity card preview 116(2) relates to a “Bird Watching Hike”, and a third activity card preview 116(3) relates to a “Fun Run”. Further, the user can create a new activity card by selecting ‘blank’ activity card preview 116(4). (Viewed another way, ‘blank’ activity card preview 116(4) is not an activity card or an activity card preview, but instead is a convenient way for the user to start the process of creating a new activity card. This aspect is discussed below relative to FIG. 1D). In the present configuration the activity card previews 116 can be thought of as more compact versions of activity cards (illustrated in Instance 3). An activity card can be thought of as a data container that contains one or more types of data relating to an activity. In other configurations, the activity card preview and the corresponding activity card may be identical. Alternately, the activity card preview may be even more compact than the illustrated version. For instance, the activity card preview may be manifest only as text (e.g., “Fun Run”).

A “Past Activities” header 118 shows activity card previews 116(5) and 116(6) which have already ‘occurred’ or been ‘completed’. Of course, more activity card previews 116 can exist in either or both of the “Your Activities” header 114 and the “Past Activities” header 118. The user can view these non-visible activities in various ways. For instance, the user may scroll or swipe the screen to see other activities. Alternatively, the user may search activities as indicated at 120 to find a specific activity card/activity card preview. The user can search for the specific activity card using any data associated with the activity card. Examples of this data are described relative to Instance 8. At this point, assume for purposes of explanation, that the user wanted to view details relating to activity card preview 116(3) and as such selects that activity card preview.

Instance 3 illustrates an activity card 122(3) that corresponds to the user selection of activity card preview 116(3) described above. In this case, the activity card shows image 124 as well as more details 126 than the corresponding activity card preview since more of the GUI 104 is dedicated to the activity card than the activity card preview in Instance 2. In this case, the details 126 relate to “What”, “When”, “Where”, “Who”, and “Discussion”, indicated generally at 128, 130, 132, 134, and 136, respectively. Of course, this is only one example of the details that can be included on an activity card. In this example the “When” 130 is listed as “9:00 A.M. Tuesday, Jan, 1, 2013”, the “Where” 132 is listed as “Marymoor Park, Redmond, Wash.”, the “Who” is listed as “User, Ben, Imran, Gail, . . . ”, and the “Discussion” is listed as “Ben-This is going to be fun” and “Gail-Loser buys”. (Of course, the user's actual name or alias would appear in most implementations, but “user” is utilized for purposes of explanation). Of course, not all variations can be illustrated. For example, in another variation, the activity card may include detail headings such as “what”, “where”, “when”, “who” and/or “discussion” among others. The user may then click to see content of a particular heading on a separate GUI. For instance, the user could click on the “discussion” heading to view discussion content, rather than having the discussion content visible on the same view as the other details. Of course, still other variations are also contemplated.

While Instance 3 represents a ‘snap shot’ of activity card 122(3), the activity card can be dynamic relative to time and/or content. For instance, assume that Instance 3 represents a view of activity card 122(3) as presented two weeks before the activity (e.g., the “Fun Run”). As the activity approaches, content of the activity card may change.

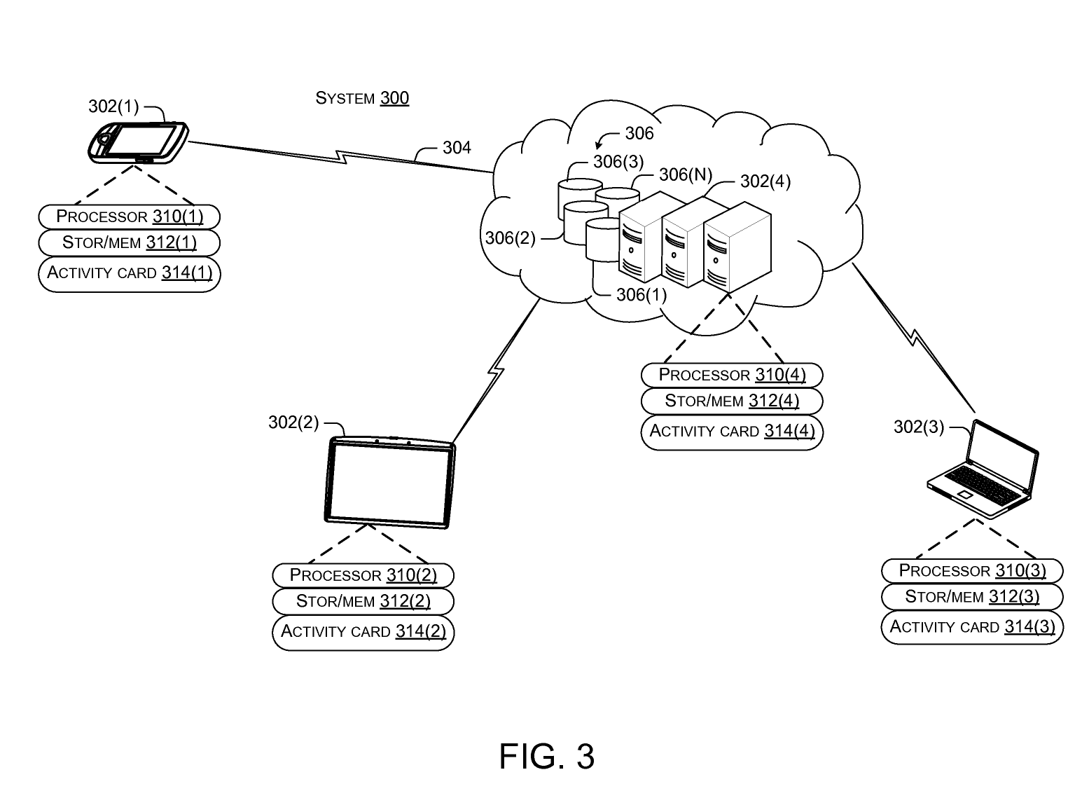

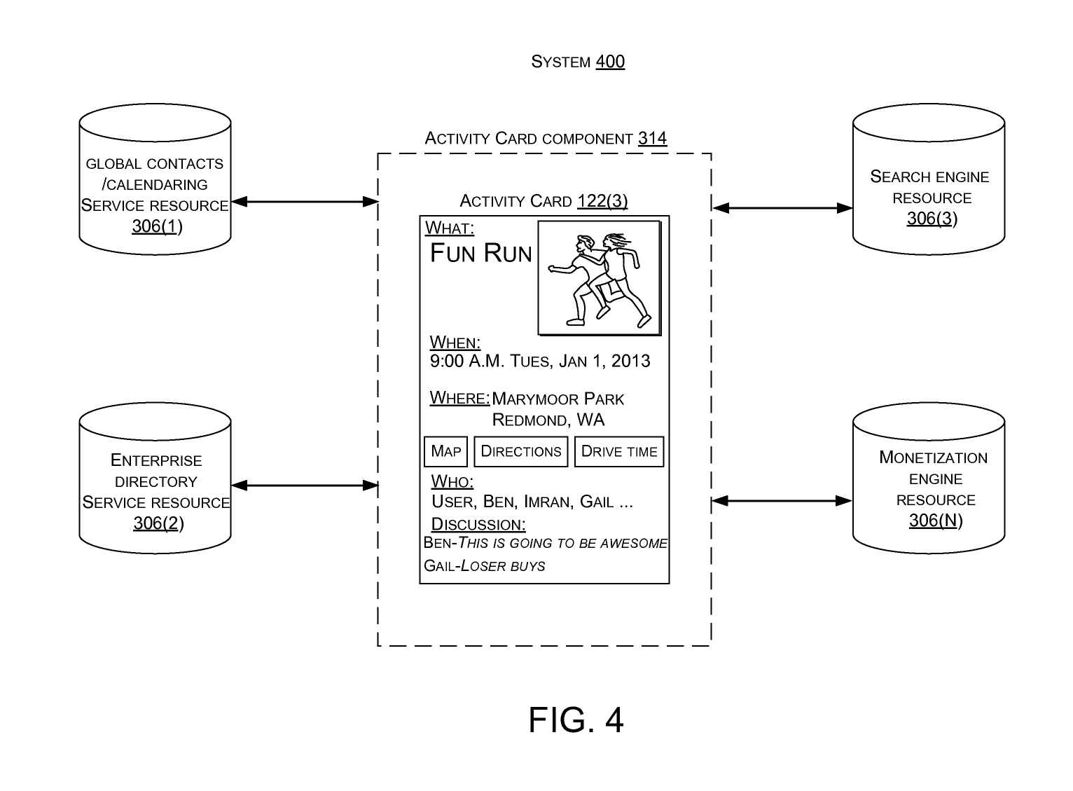

Note that alternatively, the activity card may be customized for each user (e.g., participant). Stated another way, various resources can be utilized to create and/or customize the activity card. Resources are described in more detail below relative to FIGS. 3-4. In the present example, assume that the user's daily commute passes a sporting goods store. The activity card could be temporally updated to show an advertisement from the sporting goods store indicating a running shoe sale. A caption could accompany the ad which says, “Get new running shoes for your upcoming run at Marymoor Park at the sporting goods store.” Thus, the activity card content and/or images can be analyzed for information. This information can be utilized with various resources to provide useful information to the user.

A different variation of the activity card may be generated for other users. Assume for example, that Ben likes to have energy bars when he goes running. This aspect could be determined from analyzing Ben's text entries in activity cards and/or generally and/or from his Internet commerce ordering history, among others. As such, his activity card manifestation could include a note to remember to bring energy bars to the activity and/or an ad relating to energy bars. The ad could be based upon his expected travel, such as commute routes and/or route to the activity of the activity card.

Returning to the illustrated examples, subsequent views of the dynamic nature of the activity card are shown in Instances 4-6 of FIG. 1B. Instances 4-6 provide examples of changes that may occur. Of course, while this example is described relative to the user, other participants (e.g., the other people listed under the “Who” detail 134) can also view the same or a similar variation of activity card 122(3).

Instance 4 of FIG. 1B shows a subsequent view of activity card 122(3) on computing device 102. This example activity card is generated the morning of the activity (e.g., the “Fun Run”) an hour before the activity (e.g., at 8:00 A.M.). In this case, the “When” detail 130 is updated to reflect that the activity is “Today at 9:00 A.M.”. Assume that the user adds content to the discussion: “I feel great. You guys better look out.”

The user's text is reflected in Instance 5. In order to add the new content to the discussion, earlier content may no longer be visible, but can be seen if the user ‘scrolls’ or otherwise moves through the discussion content. In this case, Gail's content remains visible, but Ben's is not. Note that the user can also get a map, directions, and/or current drive time as listed under the “Where” detail 132. These features may utilize personal data gathered about the user (in this case, the user's location as determined by the computing device). The user's privacy can be protected by only enabling this feature upon the user giving their express consent. Further, the user's information may be utilized only when the user requests a feature that utilizes the user's information. For instance, the user's location may not be tracked until the user asks for directions or current drive time. The tracking could cease when the user arrives at the event. If the user does not authorize personal information to be utilized, then a generic map and/or directions can be presented. The various implementations can be accomplished by first obtaining authorization from the user. All privacy and security procedures can be implemented to safeguard the user. Many of the described features can be accomplished even in the event that the user does not give authorization and thus no personal information is utilized.

Instance 6 shows a further example of the activity card 122(3) generated at 8:50 A.M. In this case, the “Who” detail 134 indicates that the “User is at the park”, “Ben just arrived”, “Imran is at the park”, and “Gail is stuck in traffic—10 minutes late”. Thus, the participants are provided with dynamic useful information. The status of each participant can be generated automatically. Alternatively, if the user declines use of their personal information, they can be queried about their status or allowed to provide it on their own.

Note that in another example, the activity card may be dynamically updated to remind the users (e.g., participants) when to leave and what route to take to the activity. For instance, this version of the activity card could be presented to the users one to two hours before the activity and can be updated as traffic conditions change. Further the activity card may include a visual and/or auditory alarm element to indicate to the user when it is time to leave for the activity. In such a case, the alarm can be specific to each of the individual users based upon their location, travel route, and mode of travel, among others.

FIG. 1C shows subsequent views (Instances 7-9) after the fun run activity. Instance 7 shows pictures 124(1) and 124(2) of the fun run added to the activity card 122(3). Further discussion 136 added after the activity is also evident. This configuration allows all the data associated with the activity, from creation of the activity card to perpetuity, to be persisted by the activity card. This data can include the text, images, maps, directions, GPS coordinates, etc., associated with the activity card.

Assume for purposes of example that at a later date, say two years later, the user remembers an activity where someone stepped in a mud puddle, but cannot otherwise remember the details. As indicated in Instance 8, the user can enter “mud puddle” in the search activities field 120. The activities can be searched based upon the user entry.

Instance 9 shows a subsequent view of the computing device where activity card 122(3) is once again displayed responsive to the user search. In this case, the “What”, “When”, “Where”, “Who”, and “Discussion” details 128-136 are provided for the user along with image 124. The user's search entry is illustrated in “bold” for the user at 138. The user can scroll through the images and/or text to see additional information about the activity. Thus, the activity card provides a new type of data container centered around an activity that can be persisted for the user indefinitely. The activity card can be processed or analyzed using various technologies, such as machine learning, natural language processing, optical character recognition, etc., to garner useful data from the activity card. This useful data can allow a multitude of resources to be utilized to provide features relative to the activity card. Examples of these features are described above and below.

Note that an activity card can function as a resource for suggesting, generating, and/or autopopulating details of other activity cards. Stated another way, if a user engages in an activity, the user is likely to engage in other similar activities. Thus, existing activity cards can be analyzed to determine further activity cards that may be of interest to the user. In such a case, the more activity cards the user utilizes, the quality of the activity cards as a resource increases (e.g., the understanding of the user tends to increase the more the user utilizes activity cards). The information garnered from the activity cards can be integrated with other resource information, such as calendars, contacts, and web search history, among others, to provide features that aid the user(s).

For example, if the user has participated in several activity cards relating to park league soccer games and practices, information can be gathered from the web about upcoming park league soccer activities. This information may be used to autogenerate a new activity card (e.g., proposed activity card) that can be presented to the user to accept or decline. Alternatively, the information can be utilized to suggest to the user that he/she may want to generate an activity card for an upcoming park league soccer activity. In one case, a new activity card can be generated and invitees can be suggested from the earlier park league soccer activity cards. Further, the user's calendar and/or the calendar of the other invitees can be examined to find openings and/or preferences (e.g., your calendar is open in the mornings before work and your past activity cards indicate that you prefer scheduling soccer practice before work. Further, you might want to invite these people and this soccer field can be reserved in the morning at this time). Specific activity card generation examples are described below.

Returning to the illustrated examples, FIG. 1D relates to creating a new activity card. Assume for purposes of explanation that the user now wants to create a new activity card. One way of creating an activity card is shown at Instance 10. In this case, the user can select the new activity card feature 116(4).

Instance 11 shows a new activity card 122(4). The user has initially added some details 126 to the activity card. For instance, the user has added “Dinner” to the “What” detail 128, “Friday night” to the “When” detail 130, and “Javier”, and “March” to the “Who” detail 134. The user can then click “Send” at 140. Note that the user can generate the activity card 122(4) without completing all of the detail fields. In this example, the details do not include a location (e.g., “Where” detail 132). As will be explained below, additional details can be added subsequently as the activity card evolves.

Instance 12 shows the activity card 122(4) that is generated responsive to the user selection in Instance 11. The activity card 122(4) can be sent to (or accessed by) those indicated in the “Who” detail as well as the user. In this implementation the user is automatically populated into the “Who” detail as an invitee. Instance 12 also shows that the invitees are adding further content to the activity card via the “Discussion” detail 136. In this case, the content is shown with the newest on top. Thus, the first comment in the “Discussion” is from Javier. Javier stated, “I'm in. We should go to The Steak House.” March then indicated, “I'm in too, but we should go to The Seafood House.” Javier then replies, “OK, but if we are going to The Seafood House we should invite Stephanie. She loves The Seafood House.”

Note that while not shown, the activity card could be automatically populated with content to help the users make a decision regarding one or more of the details. For instance, the discussion could be analyzed using natural language processing. Based upon the information obtained from the activity card by the natural language processing, menus, images, reviews, and/or ads from the The Seafood House and the The Steak House could be offered to and/or displayed for the users.

Returning to the illustrated examples, FIG. 1E includes Instances 13-15 which continue the scenario introduced relative to Instances 10-12. Instance 13 includes an updated view of activity card 122(4). The activity card includes an updated “Where” detail 132 that indicates “The Seafood House”. Further, the “Who” detail now includes “Stephanie”. An image of The Seafood House is also shown at 124. Stated another way, the content of the activity card, in this case the discussion, can be analyzed, such as utilizing natural language recognition/processing, or other machine learning resources. The content can be utilized to enhance the activity card. In this case, the activity card is enhanced in that an invitee is added automatically without any additional effort from the users. Further, the location (e.g., “Where:”) is automatically updated based upon the analysis of the discussion.

In some implementations, content can be added manually by one of the invitees. In other implementations, the right to add content to the details 128-134 can be reserved for the originator of the activity card 122(4) (e.g., the user in this case). In still other implementations, the content can be added automatically from the content in the “Discussion” detail 136. Further, while not expressly shown, some implementations can automatically present additional content on the activity card to help drive consensus. For example, during the discussion about which restaurant to go to, menus, reviews, coupons, advertisements, and/or images from The Steak House and The Seafood House could be automatically presented or linked on the activity card to help the participants agree on the location. Information about the selected restaurant (e.g., “The Seafood House”) could be persisted on the activity card 122(4)). Further, prior activity cards associated with The Seafood House could be analyzed. For instance, the present activity card could be populated with a snippet from the user from the last time he/she went to the The Seafood House. For instance, the snippet might include a quote added to a prior activity card discussion where the user said, “I love The Seafood House. We should go there more often.” This can be useful information that can help guide the user's decision this time whether to go to The Seafood House.

Returning to the illustrated examples, note that Instance 13 reflects ongoing dialog in Discussion 136 about the time on Friday Night. Javier initially said, “Let's go at 5.” March responded, “No, how about 5:30?” Finally, Stephanie said, “I can't get there until 6.” These possible times are indicated in the “When” detail 130. Also, to draw attention to the fact that this detail is undecided, the times in the “When” detail 130 are shown ‘bold’ to contrast them from other ‘decided’ or ‘agreed upon’ details which are shown in ‘normal’ font.

The above example discussion or ‘group chat’ is one way that activity card details can be settled. An alternative way to settle activity card details can be through ‘consensus scheduling’ or ‘consensus polling’. Consensus polling can list details such as times, dates, places, etc., as options and invitees vote upon their preferences. Individual details can be selected based upon vote count. The activity card can also provide other tools to reach consensus. For instance, the activity card could include ‘call’ and/or ‘video chat’ icons. During the negotiation, a user could simply click one of these icons to be automatically connected to the other users that are engaging in the discussion. The users could negotiate ‘in person’. An agreement could be added to the card by the users. Alternatively, voice recognition resources could be applied to the conversation and the agreement could be automatically populated onto the activity card.

Returning to the present example, Instance 14 shows continuing dialog about the time aspect. Javier said “Just leave work a little early.” March added, “I think you can make it by 5:30 if you take the side roads to avoid the traffic.” Assume that the dialog continued until the time of the activity was approaching. At this point a “lock-it” feature can be utilized to finalize any undecided details. In some implementations, the “lock-it” feature can initiate automatically as the activity approaches. In other implementations, any of the invitees can activate the “lock-it” feature. In still other implementations, only the originator of the activity card 122(4) (e.g., the user) can activate the “lock-it” feature. Assume in this example, that the user activated the “lock-it” feature as indicated at 142. For instance, the user might activate the “lock-it” feature at 2:00 P.M. on Friday so that everyone could finalize their plans for the afternoon.

As mentioned above, in some implementations, the undecided details can be decided automatically on behalf of the participants. In other cases, the invitee who activates the “lock-it” feature may be queried to decide the details. In still other implementations, the results of the consensus polling can be autopopulated in the activity card.

Instance 15 shows the activity card 122(4) presented after the user selected the “lock-it” feature at Instance 14. In this case, the “When” detail 130 now reads 6:00 P.M. and is not ‘bolded’ since it is now decided. In this case, the time was also automatically formalized from the more basic user entries (e.g., “6” to “6:00 P.M.). In summary, the features described above relative to Instances 10-15 allow a user to create an activity card without providing all of the details. Details can be added through the input of the various participants of the activity card. The “lock-it” feature provides an example of one of the features that allow resolution of any unresolved details.

### SECOND SCENARIO EXAMPLES

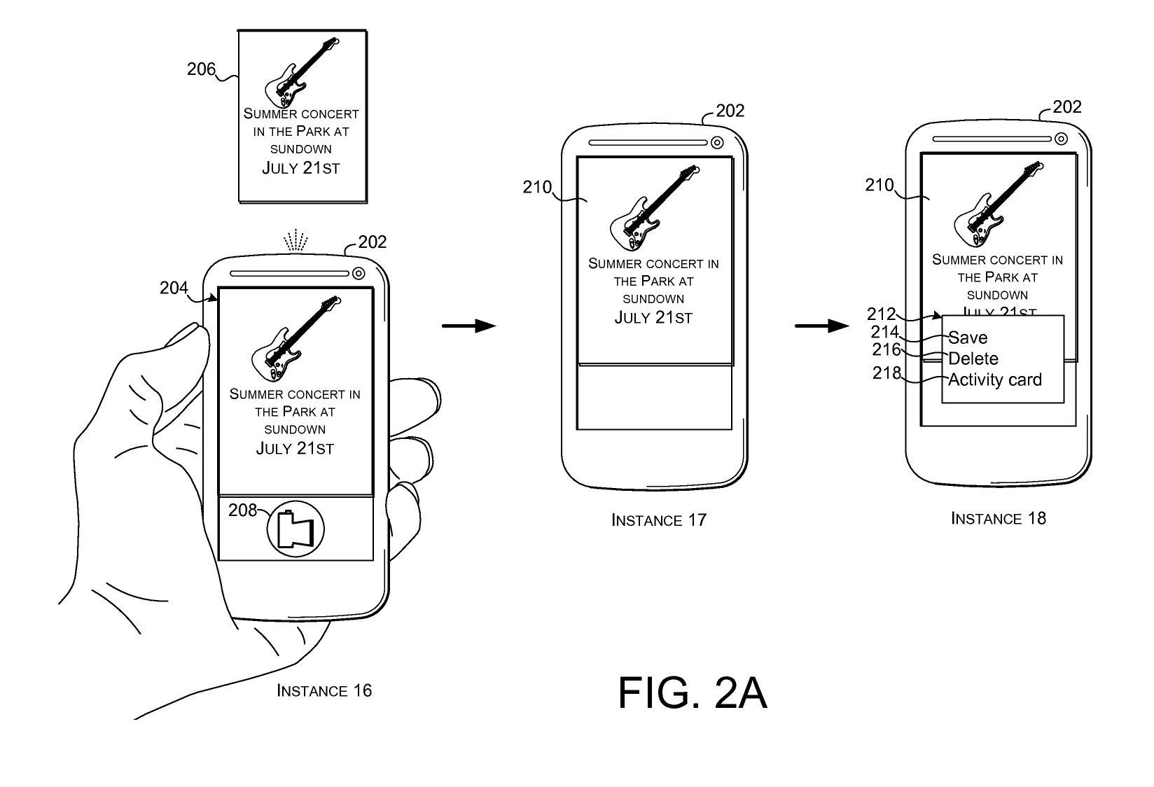

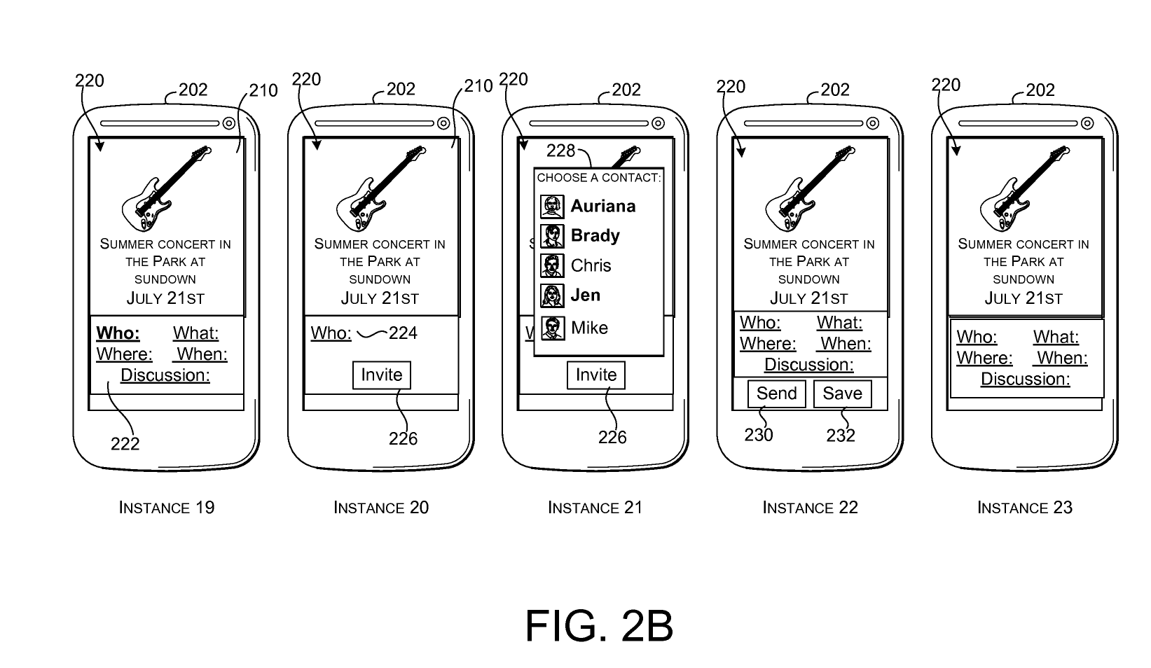

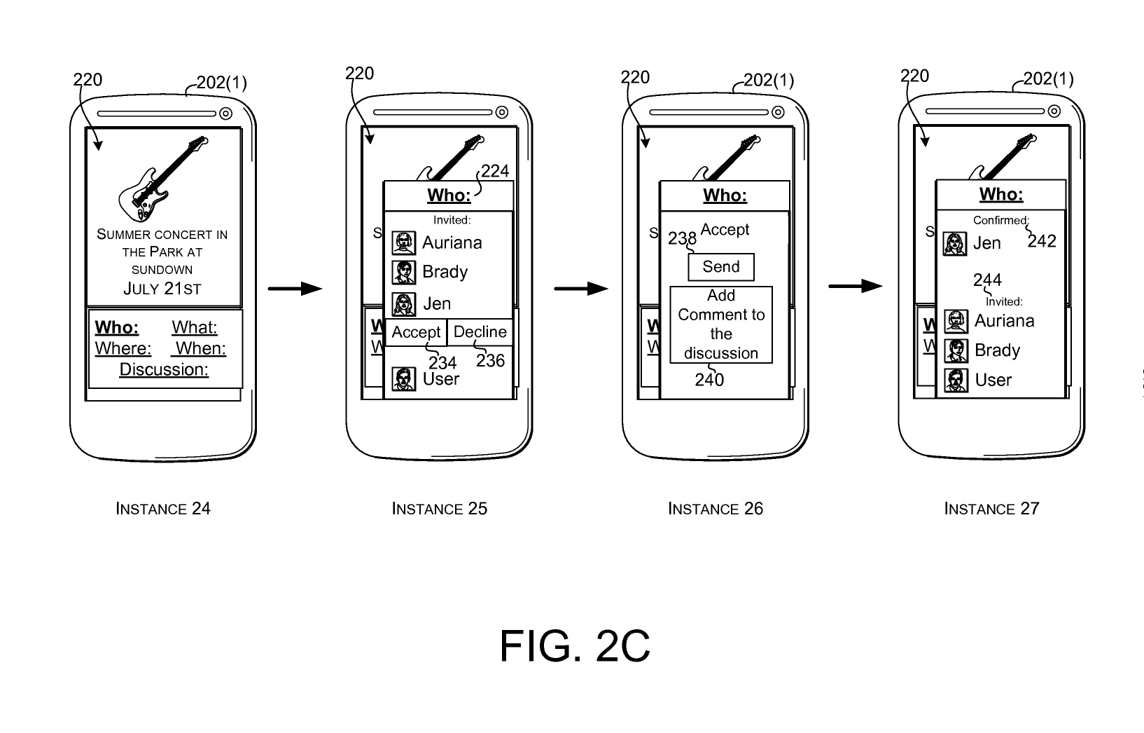

FIGS. 2A-2C show another computing device 202 that is similar to computing device 102 described above relative to FIGS. 1A-1E. Computing device 202 can present a GUI 204 that relates to activity cards. In this case, FIG. 2A shows Instances 16-18, FIG. 2B shows Instances 19-23, and FIG. 2C shows Instances 24-27.

Beginning with Instance 16, assume for purposes of explanation, that the user sees a flyer 206 for a concert. The user decides it might be fun to go to the concert. The user takes a picture of the flyer. In this case, the user takes the picture by selecting the camera icon on the computing device at 208.

Instance 17 shows the resultant picture 210 of the flyer. At this point, the user can select to convert the picture into an activity card. For instance, the user could use voice or gesture commands to launch the activity card feature. In this case, assume that the user taps a touch-sensitive display of the computing device.

Instance 18 shows a dialog box 212 generated responsive to the user tap of Instance 17. The dialog box allows the user to save the picture option at 214, delete the picture option at 216, or create an activity card option at 218. Assume that the user taps to create the activity card. The resultant activity card is shown in FIG. 2B.

Starting at Instance 19, FIG. 2B shows an activity card 220 that includes picture 210 and details 222. The listed details include “Who:”, “What:”, “Where:”, “When:”, and “Discussion:”. Some implementations can utilize various techniques to derive information from the picture to populate the activity card 220. For instance, these implementations can apply optical character recognition (OCR) techniques to the picture to obtain text corresponding to the text in the picture. This text can be used directly to populate the details of the activity card. For example, the date from the picture can be added to the “When:” detail. Alternatively or additionally, the text derived from the picture can be used as search terms of a search query to find additional information. For instance, utilizing “Summer concert in the park at sundown July 21” could yield search results that provide additional details about the event. For instance, the search results may yield a website belonging to organizers of the event. Further, the text information may be used in combination with other information from the picture to obtain the further information. For instance, metadata associated with the picture may indicate the GPS coordinates at which the image was obtained. This location information, in combination with the text information, may yield more precise search results (e.g., avoid linking to search results for a similar event on the same day at a park in another city). Further, this information can be utilized to gather additional information that can be made available on the activity card. For instance, the weather forecast can be obtained for the location on that date. If the date is relatively distant, say more than a week, the average daily temperature for that location on that date can be provided. Further, because natural language processing can be utilized on the data, additional details can be provided for the user. For example, the natural language processing can determine the meaning of ‘sundown’ (e.g., that the concert starts at sundown). With that knowledge, a resource can be accessed that indicates what time sundown occurs at that location on that date. The time could then be populated in the “When:” detail. In another example, the search could produce music from the artists that are performing at the concert. The music could be attached to activity card in a manner that it automatically plays for the user or plays upon user selection.

In the present case, assume that the user selects the “Who:” detail as indicated by the ‘bold’ appearance in the details 222. Instance 20 shows the “Who:” detail at 224 and retains the picture 210 of the activity card 220. In this case, no one has been invited yet, so the “Who:” detail does not contain any invitees. However, the user can select an invite option 226.

Instance 21 shows the activity card 220 with the user's contacts list 228. The contacts list can be a contacts list that is locally stored on computing device 202 and/or a global contacts list that is remotely stored, such in cloud-based resources. The user can select invitees from the contact list. In this case, assume that the user selected “Auriana”, “Brady”, and “Jen” as indicated by the ‘bold’ text. The user can then select the invite option 226 to configure the activity card.

In some instances an individual recipient may be associated with multiple phone numbers and/or multiple email addresses in the contacts list. The user can specify an individual phone number and/or individual email address to send the activity card. In other instances, the selection can be performed automatically. In some of these cases, the selection can be performed automatically and then presented to the user for approval. In one such example, email history and/or activity card history can be utilized to identify contacts for the user. For instance, the people that the user communicates (e.g., emails or texts, among others) often (or the most) may be suggested to the user. In another variation, the people that the user emails the most about a particular topic (e.g., music, concerts, outdoor concerts, among others) may be suggested to the user. This information could be obtained from email history, text history, and/or previous activity cards, among other sources.

Instance 22 shows the resultant activity card 220. The user can select to send the activity card at 230 or save the activity card at 232. Assume that the user selects to send the activity card.

Instance 23 shows a resultant activity card 220 that is sent to or viewable by the user and the other invitees.

Instance 24 of FIG. 2C shows another view of the activity card 220. Assume for purposes of explanation, that this view is on invitee Jen's computing device 202(1). Assume further that Jen selects the “Who:” detail as indicated in “bold”.

Instance 25 shows further aspects of the “Who:” detail 224. In this example, the “Who:” detail is superimposed over a remainder of the activity card 220. In other cases, more of the remainder of the activity card may be visible while specific details are viewed, or alternatively the remainder may be totally obscured. In this case, the details are customized for the viewer (e.g., Jen) so that the viewer can either accept or decline as indicated at 234 and 236, respectively. Assume in this case that Jen accepts at 234 (e.g., an invitee accepts and becomes a participant).

Instance 26 shows another instance of the activity card 220 generated responsive to the acceptance. This version allows Jen to “Send” the acceptance at 238 or “Add comments to the discussion” at 240. Assume that Jen selects “Send” at 238.

Instance 27 shows a subsequent view of the “Who:” detail that can be viewed by Jen or any of the invitees. This view distinguishes confirmed invitees (e.g., participants) at 242 from the invitees who have not yet responded at 244. While not expressly shown, invitees who decline can be distinguished in a similar manner.

In summary, the activity card concepts described above can enable individuals or family coordinators to plan social activities, get details to participate in an activity and quickly agree on when and where. Stated another way, these activity card concepts can enable users to float an idea and discuss it with each other. Thus, users can discover new things to do with one another. The activity card can be automatically updated to provide the latest details and can be accessed from anywhere. The activity card can also include beautiful content that can enhance the user experience. Further, the activity card can be integrated with, or augmented by, various resources to enhance the functionality offered by the activity card.

### FIRST SYSTEM EXAMPLES

FIG. 3 shows system 300 that can enable the activity card concepts described above. In this example, the system 300 includes several devices 302. In this case, the devices are manifest as a smartphone type computer 302(1), a pad type computer 302(2), a notebook type computer 302(3), and a set of cloud-based server type computers 302(4). Smartphone type computer 302(1) is similar to devices 102 and 202 described above relative to FIGS. 1A-1E and 2A-2C, respectively. (In this discussion, the use of a designator with the suffix, such as “(1)”, is intended to refer to a specific device instance. In contrast, use of the designator without a suffix is intended to be generic). Of course not all device implementations can be illustrated and other device implementations should be apparent to the skilled artisan from the description above and below.

The devices 302 can communicate over one or more networks 304 (represented by ‘lightning bolts’). The devices can also communicate with resources 306. Non-limiting examples of resources can include a global contacts/calendaring service 306(1), enterprise directory service 306(2), search engine 306(3), and monetization engine 306(N). Other non-illustrated examples of resources can include optical character recognition technologies, natural language processing/generating technologies, and/or activity card database, among others. In some cases, the present concepts can be implemented by an individual device 302 acting in isolation. In other cases, a device can implement the present concepts by operating cooperatively with one or more other devices and/or the resources 306. These variations are described in more detail below.

Devices 302 can include several elements which are defined below. For example, these devices can include a processor 310, storage/memory 312, and/or an activity card component 314. The devices can alternatively or additionally include other elements, such as input/output devices (e.g., touch, voice, and gesture), buses, graphics cards, Wi-Fi circuitry, cellular circuitry, positional circuitry (absolute location (e.g., GPS) and/or relative location (accelerometers, magnetometers, among others) etc., which are not illustrated or discussed here for sake of brevity.

The term “device”, “computer” or “computing device” as used herein can mean any type of device that has some amount of processing capability and/or storage capability. Processing capability can be provided by one or more processors (such as processor 310) that can execute data in the form of computer-readable instructions to provide a functionality. Data, such as computer-readable instructions, can be stored on storage, such as storage/memory 312 that can be internal or external to the computer. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage medium/media includes “computer-readable storage devices.” Examples of computer-readable storage devices include volatile storage media, such as RAM, and non-volatile storage media, such as hard drives, optical discs, and flash memory, among others.

Examples of devices can include traditional computing devices, such as personal computers, desktop computers, notebook computers, cell phones, smart phones, personal digital assistants, pad type computers, mobile computers, cameras, or any of a myriad of ever-evolving or yet to be developed types of computing devices. A mobile computer can be any type of computing device that is readily transported by a user and has a self-contained power source (e.g., battery). Aspects of system 300 can be manifest on a single device or distributed over multiple devices.

In the illustrated implementation devices 302 are configured with a general purpose processor 310 and storage/memory 312. In some configurations, a device can include a system on a chip (SOC) type design. In such a case, functionality provided by the device can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPU), graphical processing units (CPUs), controllers, microcontrollers, processor cores, or other types of processing devices suitable for implementation both in conventional computing architectures as well as SOC designs.

In some configurations, the activity card component 314 can be installed as hardware, firmware, or software during manufacture of the device 302 or by an intermediary that prepares the device for sale to the end user. In other instances, the end user may install the activity card component 314, such as in the form of a downloadable application. Further, in some instances individual devices 302 can include robust activity card components. In other cases individual devices may have less robust or thin activity card components where a majority of the functionality is performed by other devices, such as cloud based devices, for presentation on the thin device. In some cases, the local device can provide a web-view of content generated remotely, such as by the cloud based devices.

Stated another way, in some implementations, an individual device, such as device 302(1) may have a less robust instance of the activity card component 314 such that some or all of the functionality provided by the activity card component 314(1) is performed remotely, such as at cloud-based device 302(4) and communicated back to device 302(1) for presentation to the user. Further, the activity card component may include individual resources 306 or access individual resources. For example, the activity card component may include a natural language processing/generation resource or may access a remote natural language processing/generation resource.

The activity card component 314 can be a freestanding application or the activity card component can be an element of a contact management application or a calendaring application, among others. Examples of contact management applications can include Outlook® from Microsoft® Corporation, Apple Contacts™ and/or Google Gmail™.

Alternatively or additionally to being an element of a contact management application or a calendaring application, activity card component 314 can generate and/or present activity cards. The activity card component can integrate the activity cards with the resources 306. For example, the activity card component can utilize the resources 306 to determine likely invitees for a user who is initiating an activity card. The activity card component can communicate with the global contacts/calendaring resource 306(1) and/or the enterprise directory service resource 306(2) to identify dates and times when the user and the invitees are available. The activity card component can utilize the search engine resource 306(3) and/or the monetization engine resource 306(N) to identify content to populate the activity card and/or to identify other activity cards that may be of interest to the user. For instance, in the ‘the sporting goods store’ example described above, the sporting goods store may make an arrangement with the monetization engine to put an ad in the activity card. Alternatively or additionally, the sporting goods store may arrange to generate an activity card about its own weekly fun run and invite the user to the store's fun run based upon the user's other activity cards (e.g., the fun run described above relative to FIGS. 1A-1C).

Activity card component 314 can be configured to cause a GUI to be presented to a user on the user's computing device. Examples of activity cards are described in detail above. Briefly, the activity card can include content provided by the user. The activity card component can alternatively or additionally autopopulate the activity card with content derived from the user content. For instance, the activity card component can use the user entered content, such as a photograph, metadata, and/or an activity name as search terms to obtain additional information from resources 306. The activity card component can be configured to allow recipients of the activity card to negotiate details of the activity card. Further, in some implementations, the activity card component can enable a feature that is configured to stop the negotiation and lock the details. In some implementations, the activity card component can also generate activity cards that the user may be interested in based upon an analysis of the user's data. Further still, the activity card component can identify activity cards that the user may be interested in and present them to the user. Several of these aspects are described above by way of example.

In various implementations, the activity card component 314 can enable users to schedule and discover everyday events with the simplicity of SMS, yet provide additional benefits such as: float ideas, support group chat, create beautiful invitations, support negotiations and polling. The activity card component can enable a group to plan and communicate around topics of interest in a fun way. The activity card component can discover activities based on location and interests. For instance, the activity card component can recognize details, such as when, where, and/or who and provide intelligence through tools such as weather, maps, traffic, places, and tips that make the event organization and participation experience more enjoyable. The activity card component can provide a way to negotiate details, such as when and/or where, through social banter.

The activity card component 314 can provide details and notifications to help the user do an activity, including the ability for a user to indicate whereabouts. In some cases, the activity card component can be integrated with the calendar solution that users use on a daily basis (e.g., Outlook® brand calendaring product from Microsoft® Corp.). The activity card component can provide a way to personalize information for participants through notes and photos. It can also provide a way for users to share activity information with others easily, i.e. friends, significant other, family, etc.

### SECOND SYSTEM EXAMPLES

FIG. 4 shows system 400 that can enable the activity card concepts described above. In this example, the system 400 includes activity card 122(3). The activity card can be generated and/or refined by activity card component 314 utilizing resources 306. The resources can be local or remote relative to the activity card component. The activity card component can utilize individual resources to obtain data related to an activity card that can then be leveraged with other resources. For instance, the activity card component can utilize a natural language processing resource to analyze content on the activity card, such as the user discussion. The activity card component can then utilize the output of the natural language processing resource to facilitate a meaningful search utilizing the search engine resources. The activity card component can then populate some of the search results on the activity card. Alternatively or additionally, the activity card component could supply the output of the natural language processing and/or the search results to the monetization engine resource to obtain a germane ad that the activity card component can then populate on the activity card. The activity card can provide a persistent data container related to an activity of interest to the user. The activity card component 314 can integrate the resources into creation and customization of the activity card to enhance the user experience.

### FIRST METHOD EXAMPLE

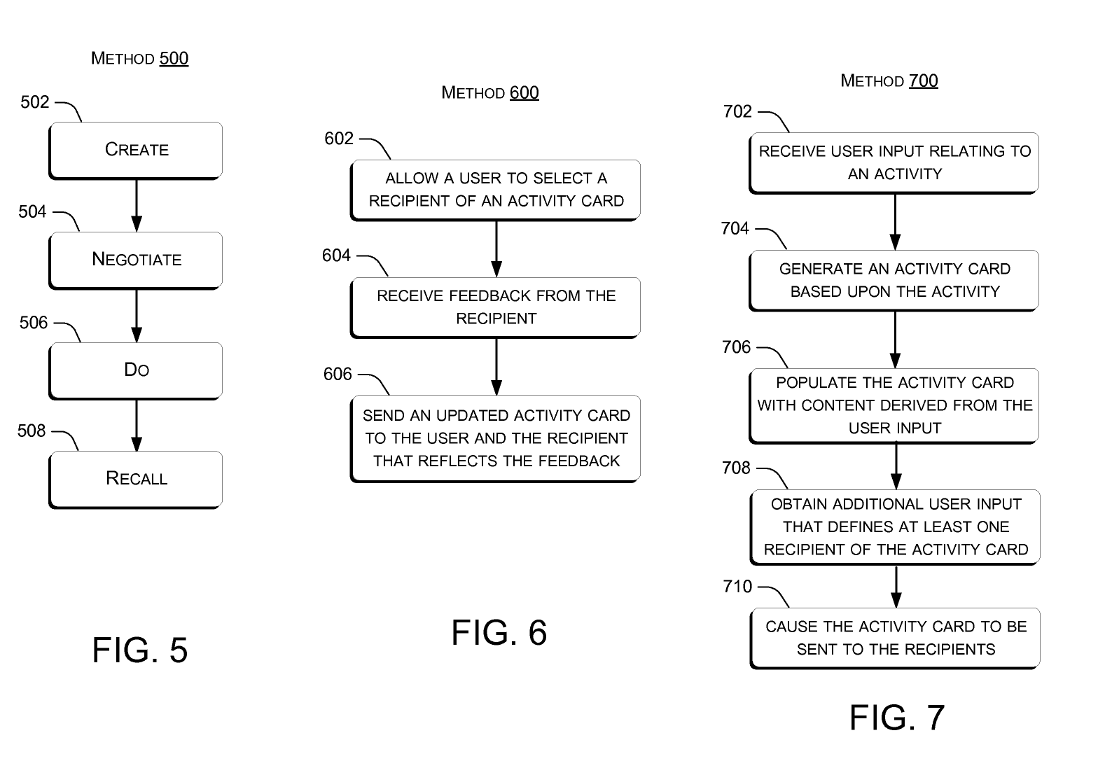

FIG. 5 shows a flowchart of a method 500 relating to activity cards.

The method can aid in creating an activity card at 502. Users can create activity cards in a light-weight manner, i.e. typing in a title for the activity card or converting a photo or location into an activity card. Various methods can be utilized to select recipients for the activity card. In one case, a tool such as a people and date/time picker can enable the user to invite friends and family to join them for an activity defined by the activity card. The method can augment the user supplied data to create richness to the activity card. For example, the method can pull in details about a place through integration with mapping services, traffic services, weather services, etc.

The method can allow the user to create an activity card by typing in natural language text or taking a photo. Additional details about the activity, such as who, where, when are not mandatory at this phase. The user can simply park an idea about an activity that the user wants to do in the future.

In some cases, the invitees can be manually notified, such as through SMS, that they should check for a new activity card. The invitee can view the activity card and accept or decline.

The method can enable negotiations via the activity card regarding details about the activity at 504. For instance, the activity card can allow the invitees to see who has been invited, who is coming (e.g., participants), and who is not. The user can view and discuss activity details through updates to the activity card.

Stated another way, the method can enable a group of friends, co-workers, or family members to get together and organize an activity. The user can float an idea on the activity card and invite others to discuss and join them in doing an activity. The negotiation process can allow the activity card to get richer as it moves from conception to the point where the participants actually do the activity.

The method can enable the participants to do the activity defined by the activity card at 506. Details can be solidified so that as the activity approaches, the activity card can provide the details to the participants. The method can obtain details to augment the participant provided details. For example, the method can provide maps, weather, and/or traffic details, among others.

The method can facilitate the participants recalling the activity via the activity card at 508. The participants can add comments and/or images during and/or after the activity. The activity card can function as a searchable data container about the activity that can be recalled and reviewed at a later date.

### SECOND METHOD EXAMPLE

FIG. 6 shows a flowchart of an activity card method or technique 600 that is consistent with at least some implementations of the present concepts.

At block 602 the method can allow a user to select a recipient of an activity card.

At block 604 the method can receive feedback from the recipient regarding at least one of a location, a time, and further recipients of the activity card.

At block 606 the method can send an updated activity card to the user and the recipient that reflects the feedback.

### THIRD METHOD EXAMPLE

FIG. 7 shows a flowchart of an activity card method or technique 700 that is consistent with at least some implementations of the present concepts.

At block 702 the method can receive user input relating to an activity.

At block 704 the method can generate an activity card based upon the activity.

At block 706 the method can populate the activity card with content derived from the user input.

At block 708 the method can obtain additional user input that defines at least one recipient of the activity card.

At block 710 the method can cause the activity card to be sent to the recipients.

The methods can be performed by the computing devices described above relative to FIGS. 1A-1E, 2A-2C, and/or 3, and/or by other devices and/or systems.

The order in which the methods are described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method. In one case, the method is stored on computer-readable storage medium/media as a set of instructions such that execution by a computing device causes the computing device to perform the method.

### CONCLUSION

Although techniques, methods, devices, systems, etc., pertaining to activity cards are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
allowing a user to select a recipient of an activity card;
receiving feedback from the recipient regarding at least one of a location, a time, and further recipients of the activity card; and,
sending an updated activity card to the user and the recipient that reflects the feedback, wherein the sending is performed by a computing device.

2. The method of claim 1, wherein the allowing comprises presenting a contacts list associated with the user and allowing the user to select the recipient from the contacts list.

3. The method of claim 2, further comprising, in an instance where the recipient is associated with multiple phone numbers, enabling the user to specify an individual phone number and the sending comprises sending the updated activity card to the individual phone number.

4. The method of claim 2, further comprising, in an instance where the recipient is associated with multiple email addresses, enabling the user to specify an individual email address and the sending comprises sending the updated activity card to the individual email address.

5. At least one computer-readable storage medium having instructions stored thereon that when executed by a computing device cause the computing device to perform acts, comprising:
receiving user input relating to an activity;
generating an activity card based upon the activity;
populating the activity card with content derived from the user input;
obtaining additional user input that defines at least one recipient of the activity card; and,
causing the activity card to be sent to the at least one recipient.

6. The computer-readable storage medium of claim 5, wherein the receiving user input comprises receiving a photograph.

7. The computer-readable storage medium of claim 5, wherein the generating comprises analyzing communications of the user relating to the activity or similar activities to identify potential recipients and further comprising suggesting the potential recipients to the user.

8. The computer-readable storage medium of claim 5, wherein the generating comprises analyzing other existing activity cards.

9. The computer-readable storage medium of claim 6, wherein the populating comprises performing optical character recognition on the photograph to derive text from the photograph and applying natural language processing to the text and using at least some of the text in a search query.

10. The computer-readable storage medium of claim 6, wherein the populating comprises obtaining metadata from the photograph and utilizing the metadata to obtain the content.

11. The computer-readable storage medium of claim 10, wherein the metadata comprises location information and the content relates to a map of the location.

12. The computer-readable storage medium of claim 5, wherein the generating comprises presenting the activity card on a graphical user interface of a computing device.

13. The computer-readable storage medium of claim 5, wherein the generating comprises sending the activity card for presentation on a remote computing device.

14. The computer-readable storage medium of claim 5, wherein the obtaining comprises presenting a contacts list to the user and allowing the user to select the at least one recipient from the contacts list.

15. The computer-readable storage medium of claim 5, wherein the obtaining comprises presenting available dates and times from a calendar of the user and a calendar of the at least one recipient.

16. A system, comprising:
a display;
storage having instructions stored thereon;
a processor configured to process the instructions to create a graphical user interface (GUI) on the display; and,
the GUI comprising an activity card, wherein the activity card includes content provided by a user and autopopulated content derived from the user content, and wherein the activity card is configured to allow negotiation between recipients of details of the activity card, and wherein the activity card includes a feature that is configured to stop the negotiation and lock the details.

17. The system of claim 16, embodied on a single device.

18. The system of claim 16, wherein the instructions comprise an activity card application.

19. The system of claim 16, wherein the activity card is generated remotely and wherein the instructions cause the remotely generated activity card to be presented on the GUI.

20. The system of claim 16, wherein the instructions are further configured to cause the processor to apply natural language processing to the user content and further configured to utilize results of the natural language processing to obtain the autopopulated content from a remote resource and to integrate the autopopulated content with the user content.
